(19) United States
(12) Patent Application Publication
(10) Pub. No.: US 2024/0010901 A1
(43) Pub. Date: Jan. 11, 2024

(54) Thermally Conductive Polymer Composition

(71) Applicant: Ticona LLC, Florence, KY (US)

(72) Inventors: Yuehua Yu, Cincinnati, OH (US); Prabuddha Bansal, Florence, KY (US); Christopher McGrady, Walton, KY (US)

(21) Appl. No.: 18/339,261

(22) Filed: Jun. 22, 2023

Related U.S. Application Data
(60) Provisional application No. 63/389,046, filed on Jul. 14, 2022.
(60) Provisional application No. 63/359,014, filed on Jul. 7, 2022.

(51) Int. Cl. C09K 5/14; C08K 3/34; B60H 1/00

(52) U.S. Cl. CPC C09K 5/14; C08K 3/34; B60H 1/00278; C08K 2003/343; C08K 2201/005; C08K 2201/006; C08K 2201/001; B60H 2001/00307; H01M 50/446

(57) ABSTRACT

A polymer composition comprising 100 parts by weight of a polymer matrix that includes a polyarylene sulfide and from about 40 to about 200 parts by weight of a plurality of mineral particles dispersed within the polymer matrix is provided. The polymer composition exhibits an in-plane thermal conductivity of about 2.5 W/m-K or more as determined in accordance with ASTM E1461-13(2022).

### RELATED APPLICATIONS

The present application is based upon and claims priority to U.S. Provisional Patent Application Ser. No. 63/359,014, having a filing date of Jul. 7, 2022, and U.S. Provisional Patent Application Ser. No. 63/389,046, having a filing date of Jul. 14, 2022, which are incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. High performance polymeric materials are often employed in the electric vehicle for various components, such as in high voltage connectors, power converter housings, battery assembly housings, fluid pumps, inverters, bobbins, busbars, twisted cables, individual sense lead wires, wire crimps, grommet moldings, quick connectors, tees, interconnects, guide rails, sealing rings (e.g., brushless direct current sealing rings, battery cell sealing rings, etc.), etc. Unfortunately, however, many conventional polymeric materials will not support the power rating of these devices without additional help in transferring heat away from the component. This may be accomplished by attaching the device to a thermal “heat sink”, which is in contact with a metal base plate or flange. The purpose of the heat sink is to draw heat from the component and then dissipate the heat over a much larger area. Unfortunately, however, such heat sinks tend to occupy a large volume of space, which is undesired. As such, a need currently exists for polymeric materials that have improved thermal conductivity without the need for a heat sink.

### SUMMARY OF THE INVENTION

In accordance with one embodiment of the present invention, a polymer composition is disclosed that comprises 100 parts by weight of a polymer matrix that includes a polyarylene sulfide and from about 70 to about 250 parts by weight of a plurality of mineral particles dispersed within the polymer matrix. The polymer composition exhibits an in-plane thermal conductivity of about 2 W/m-K or more as determined in accordance with ASTM E1461-13(2022).

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates an electric vehicle including components that may incorporate a polymer composition as disclosed herein;

FIG. 2 illustrates one embodiment of a busbar as may incorporate a polymer composition as disclosed herein;

FIG. 3 illustrates a battery assembly that may employ components that may incorporate a polymer composition as disclosed herein;

FIG. 4 illustrates an electronic system as may include components that may incorporate a polymer composition as disclosed herein;

FIG. 5 illustrates a current sensor as may be included in an electronic system as in FIG. 4;

FIG. 6 illustrates an inverter system as may be present in an electric car including components that may incorporate a polymer composition as disclosed herein;

FIG. 7 is a perspective view of one embodiment of a connector that may incorporate a polymer composition as disclosed herein;

FIG. 8 is a plan view of the connector of FIG. 7 in which the first and second connector portions are disengaged;

FIG. 9 is a plan view of the connector of FIG. 7 in which the first and second connector portions are engaged;

FIG. 10 illustrates examples of components that may incorporate a polymer composition as disclosed herein;

FIG. 11 illustrates additional components that may incorporate a polymer composition as disclosed herein;

FIG. 12 illustrates a low temperature thermal loop as may include components that may incorporate a polymer composition as disclosed herein;

FIG. 13 illustrates a high temperature thermal loop as may include components that may incorporate a polymer composition as disclosed herein; and

FIG. 14 illustrates one embodiment of a coolant pump as may incorporate a polymer composition as disclosed herein.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition includes a polyarylene sulfide and a plurality of mineral particles dispersed within the polymer matrix. By selectively controlling the specific nature and relative concentration of the components of the polymer composition, the present inventors have discovered that the resulting composition can exhibit a unique combination of properties that enables it to be readily employed in a wide variety of product applications (e.g., electric vehicle) even at relatively small part thickness values, such as about 4 millimeters or less, in some embodiments about from about 0.2 to about 3.2 millimeters, in some embodiments from about 0.4 to about 2.5 millimeters, and in some embodiments, from about 0.8 to about 2 millimeters.

The polymer composition may, for example, exhibit an in-plane (or “flow”) thermal conductivity of about 2 W/m-K or more, in some embodiments about 2.5 W/m-K or more, in some embodiments about 3 to about 8 W/m-K, and in some embodiments, from about 3.2 to about 6 W/m-K, as determined in accordance with ASTM E 1461-13(2022). Similarly, the polymer composition may exhibit a cross-plane (or “cross-flow”) thermal conductivity of about 2 W/m-K or more, in some embodiments about 2.5 W/m-K or more, in some embodiments about 3 to about 8 W/m-K, and in some embodiments, from about 3.2 to about 6 W/m-K, as determined in accordance with ASTM E 1461-13(2022). The composition may also exhibit a through-plane thermal conductivity of about 0.2 W/m-K or more, in some embodiments about 0.4 W/m-K or more, in some embodiments about 0.5 to about 4 W/m-K, and in some embodiments, from about to about 2 W/m-K, as determined in accordance with ASTM E 1461-13(2022). Such high thermal conductivity values allow the composition to be capable of creating a thermal pathway for heat transfer away from an electrical component within which it is employed. In this manner, “hot spots” can be quickly eliminated and the overall temperature can be lowered during use. Notably, it has been discovered that such a thermal conductivity can be achieved without use of conventional materials having a high degree of intrinsic thermal conductivity. For example, the polymer composition may be generally free of fillers having an intrinsic thermal conductivity of 50 W/m-K or more, in some embodiments 100 W/m-K or more, and in some embodiments, 150 W/m-K or more. Examples of such high intrinsic thermally conductive materials may include, for instance, boron nitride, aluminum nitride, magnesium silicon nitride, graphite (e.g., expanded graphite), silicon carbide, carbon nanotubes, zinc oxide, magnesium oxide, beryllium oxide, zirconium oxide, yttrium oxide, aluminum powder, and copper powder. While it is normally desired to minimize the presence of such high intrinsic thermally conductive materials, they may nevertheless be present in a relatively small percentage in certain embodiments, such as in an amount of about 10 wt. % or less, in some embodiments about 5 wt. % or less, and in some embodiments, from about 0.01 wt. % to about 2 wt. % of the polymer composition.

While exhibiting good thermal conductivity, the composition may still exhibit good flow properties as reflected by a relatively low melt viscosity, such as about 30 kP or less, in some embodiments about 20 kP or less, in some embodiments about 10 kP or less, in some embodiments about 5 kP or less, and in some embodiments, from about 2 to about 50 kP, as determined in accordance with ISO 11443:2021 at about 310° C. and a shear rate of 400 s⁻¹. Despite having a low melt viscosity, the polymer composition may nevertheless maintain a high degree of strength, which can provide enhanced flexibility for the resulting component. The polymer composition may, for example, exhibit a tensile stress at break (i.e., strength) of from about 40 MPa to about 300 MPa, in some embodiments from about 50 MPa to about 250 MPa, and in some embodiments, from about 55 to about 200 MPa; a tensile break strain (i.e., elongation) of about 0.3% or more, in some embodiments from about 0.4% to about 8%, and in some embodiments, from about 0.5% to about 5%; and/or a tensile modulus of from about 5,000 to about 30,000 MPa, in some embodiments from about 6,000 MPa to about 25,000 MPa, and in some embodiments, from about 10,000 MPa to about 22,000 MPa. The tensile properties may be determined in accordance with ISO 527:2019 at a temperature of 23° C. The composition may also exhibit a flexural strength of about 20 MPa or more, in some embodiments from about 25 to about 200 MPa, in some embodiments from about 30 to about 150 MPa, and in some embodiments, from about 35 to about 100 MPa and/or a flexural modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The flexural properties may be determined in accordance with ISO 178:2019 at a temperature of 23° C. The polymer composition may also exhibit a high impact strength, which can provide enhanced flexibility for the resulting part. For example, the polymer composition may exhibit an unnotched Charpy impact strength of about 2 kJ/m² or more, in some embodiments from about 4 to about 40 kJ/m², and in some embodiments, from about 5 to about 20 kJ/m², as determined at a temperature of 23° C. in accordance with ISO 179-1:2010.

The polymer composition may also exhibit good heat resistance and flame retardancy. The melting temperature of the composition may, for instance, be from about 250° C. to about 440° C., in some embodiments from about 260° C. to about 400° C., and in some embodiments, from about 280° C. to about 380° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, range be about 260° C. or more, in some embodiments from about 120° C. to about 300° C., and in some embodiments, from about 210° C. to about 280° C., such as determined in accordance with ISO 75:2013 at a load of 1.8 MPa. Such high DTUL values can, among other things, allow the use of high speed and reliable surface mounting processes for mating the structure with other components of an electrical component. The flame retardant properties of the composition may likewise be characterized in accordance the procedure of Underwriter's Laboratory Bulletin 94 entitled “Tests for Flammability of Plastic Materials, UL94.” Several ratings can be applied based on the time to extinguish ((total flame time of a set of 5 specimens) and ability to resist dripping as described in more detail below. According to this procedure, for example, the composition may exhibit a V0 rating at a part thickness such as noted above (e.g., from about 0.4 to about 3.2 millimeters, e.g., 0.4, 0.8, or 1.6 millimeters), which means that it has a total flame time of about 50 seconds or less. To achieve a V0 rating, the composition may also exhibit a total number of drips of burning particles that ignite cotton of 0.

The polymer composition may also exhibit a low dielectric constant over a wide range of frequencies, making it particularly suitable for use in 5G applications. That is, the polymer composition may exhibit a low dielectric constant of about 5 or less, in some embodiments about 4.5 or less, in some embodiments from about 0.1 to about 4.4, in some embodiments from about 1 to about 4.3, and in some embodiments, from about 2 to about 4.2, as determined by the split post resonator method over typical 5G frequencies (e.g., 2 GHz or 10 GHz). The dissipation factor of the polymer composition, which is a measure of the loss rate of energy, may likewise be about 0.05 or less, in some embodiments about 0.01 or less, in some embodiments from about 0.0001 to about 0.008, and in some embodiments from about 0.0002 to about 0.006 over typical 5G frequencies (e.g., 2 or 10 GHz).

Various embodiments of the present invention will now be described in more detail.

### I. Polymer Composition

A. Polymer Matrix

The polymer matrix typically constitutes from about 30 wt. % to about 70 wt. %, in some embodiments from about 35 wt. % to about 65 wt. %, and in some embodiments, from about 40 wt. % to about 60 wt. % of the polymer composition. The polymer matrix contains at least one polyarylene sulfide. For example, polyarylene sulfides typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

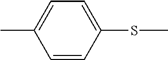

and segments having the structure of formula:

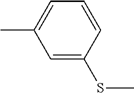

or segments having the structure of formula:

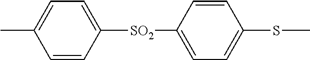

The polyarylene sulfide may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any optional impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diam inodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The melt flow rate of a polyarylene sulfide may be from about 100 to about 800 grams per 10 minutes (“g/10 min”), in some embodiments from about 200 to about 700 g/10 min, and in some embodiments, from about 300 to about 600 g/10 min, as determined in accordance with ISO 1133 at a load of 5 kg and temperature of 316° C.

The polyarylene sulfides, such as described above, typically have a DTUL value of from about 70° C. to about 220° C., in some embodiments from about 90° C. to about 200° C., and in some embodiments, from about 120° C. to about 180° C. as determined in accordance with ISO 75-2:2013 at a load of 1.8 MPa. The polyarylene sulfides likewise typically have a glass transition temperature of from about 50° C. to about 120° C., in some embodiments from about 60° C. to about 115° C., and in some embodiments, from about 70° C. to about 110° C., as well as a melting temperature of from about 220° C. to about 340° C., in some embodiments from about 240° C. to about 320° C., and in some embodiments, from about 260° C. to about 300° C.

B. Mineral Particles

The polymer composition also contains mineral particles that are distributed within the polymer matrix. Such mineral particles typically constitute from about 70 to about 250 parts by weight, in some embodiments from about 75 to about 200 parts by weight, and in some embodiments, from about 90 to about 190 parts by weight per 100 parts by weight of the polymer matrix. The mineral particles may, for instance, constitute from about 30 wt. % to about 70 wt. %, in some embodiments from about 35 wt. % to about 65 wt. %, and in some embodiments, from about 40 wt. % to about 60 wt. % of the polymer composition. The particles are typically formed from a natural and/or synthetic silicate mineral, such as talc, mica, halloysite, kaolinite, illite, montmorillonite, vermiculite, palygorskite, pyrophyllite, calcium silicate, aluminum silicate, wollastonite, etc. Talc is particularly suitable for use in the polymer composition. The shape of the particles may vary as desired, such as granular, flake-shaped, etc. The particles typically have a median particle diameter (D50) of from about 1 to about 25 micrometers, in some embodiments from about 2 to about 15 micrometers, and in some embodiments, from about 4 to about 10 micrometers, as determined by sedimentation analysis (e.g., Sedigraph 5120). If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

C. Optional Components

In addition to the components noted above, the polymer composition may also contain a variety of other optional components to help improve its overall properties. For example, the polymer composition may contain an impact modifier. When employed, the impact modifier(s) may constitute from about 1 to about 20 parts, in some embodiments from about 2 to about 15 parts, and in some embodiments, from about 5 to about 10 parts by weight per 100 parts by weight of the polyarylene sulfide(s). For example, the impact modifiers may constitute from about 0.1 wt. % to about 20 wt. %, in some embodiments from about 0.5 wt. % to about 15 wt. %, and in some embodiments, from about 1 wt. % to about 10 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

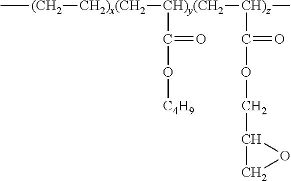

wherein, x, y, and z are 1 or greater.

The relative portion of the monomeric component(s) may be selected to achieve a balance between epoxy-reactivity and melt flow rate. More particularly, high epoxy monomer contents can result in good reactivity with the polyarylene sulfide, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

If desired, additional impact modifiers may also be employed in combination with the epoxy-functional impact modifier. For example, the additional impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the PEBAX™ trade name. The polyamide blocks may be derived from a copolymer of a diacid component and a diamine component or may be prepared by homopolymerization of a cyclic lactam. The polyether block may be derived from homo- or copolymers of cyclic ethers such as ethylene oxide, propylene oxide, and tetrahydrofuran.

A fibrous filler may also be employed in the polymer composition. Such fibrous fillers typically constitute from about 10 to about 80 parts, in some embodiments from about 20 to about 75 parts, and in some embodiments, from about 25 to about 60 parts by weight per 100 parts by weight of the polyarylene sulfide(s). When employed, for example, fibrous fillers may constitute from about 10 wt. % to about 60 wt. %, in some embodiments from about 15 wt. % to about 50 wt. %, and in some embodiments, from about 20 wt. % to about 45 wt. % of the polymer composition.

Any of a variety of different types of fibers may generally be employed, such as those inorganic fibers that are derived from glass; silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers are particularly suitable for use in the present invention, such as those formed from E-glass, A-glass, C-glass, D-glass, AR-glass, R-glass, S1-glass, S2-glass, etc., as well as mixtures thereof. If desired, the glass fibers may be provided with a sizing agent or other coating as is known in the art.

The fibers may have any desired cross-sectional shape, such as circular, flat, etc. In certain embodiments, it may be desirable to employ fibers having a relatively flat cross-sectional dimension in that they have an aspect ratio (i.e., cross-sectional width divided by cross-sectional thickness) of from about 1.5 to about 10, in some embodiments from about 2 to about 8, and in some embodiments, from about 3 to about 5. When such flat fibers are employed in a certain concentration, they may further improve the mechanical properties of the molded part without having a substantial adverse impact on the melt viscosity of the polymer composition. The fibers may, for example, have a nominal width of from about 1 to about 50 micrometers, in some embodiments from about 5 to about 50 micrometers, and in some embodiments, from about 10 to about 35 micrometers. The fibers may also have a nominal thickness of from about 0.5 to about 30 micrometers, in some embodiments from about 1 to about 20 micrometers, and in some embodiments, from about 3 to about 15 micrometers. Further, the fibers may have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. In a molded part, the volume average length of the fibers may be from about 10 to about 500 micrometers, in some embodiments from about 100 to about 400 micrometers, and in some embodiments, from about 150 to about 350 micrometers.

If desired, a siloxane polymer may also be employed in the polymer composition. When employed, such siloxane polymer(s) may constitute from about 0.05 to about 10 parts, in some embodiments from about 0.1 to about 8 parts, and in some embodiments, from about 0.5 to about 5 parts by weight per 100 parts by weight of the polyarylene sulfide(s). For example, siloxane polymer(s) may constitute from about 0.05 wt. % to about 15 wt. %, in some embodiments from about 0.5 wt. % to about 10 wt. %, and in some embodiments, from about 1 wt. % to about 8 wt. % of the polymer composition. Without intending to be limited by theory, it is believed that the siloxane polymer can, among other things, improve the processing of the composition, such as by providing better mold filling, internal lubrication, mold release, etc. Further, it is also believed that the siloxane polymer is less likely to migrate or diffuse to the surface of the composition, which further minimizes the likelihood of phase separation and further assists in dampening impact energy. The siloxane polymer generally has a high molecular weight, such as a weight average molecular weight of about 100,000 grams per mole or more, in some embodiments about 200,000 grams per mole or more, and in some embodiments, from about 500,000 grams per mole to about 2,000,000 grams per mole. The siloxane polymer may also have a relatively high kinematic viscosity at 25° C., such as about 10,000 centistokes or more, in some embodiments about 30,000 centistokes or more, and in some embodiments, from about 50,000 to about 50×10⁶ centistokes, such as from about 1×10⁶ to 50×10⁶ centistokes. The viscosity of a siloxane polymer can be determined according to ASTM D445-21.

Any of a variety of high molecular weight siloxane polymers may generally be employed in the polymer composition. A high molecular weight siloxane polymer generally includes siloxane-based monomer residue repeating units. As used herein, “siloxane” denotes a monomer residue repeat unit having the structure:

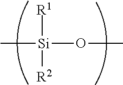

where R¹ and R² are independently hydrogen or a hydrocarbyl moiety, which is known as an “M” group in silicone chemistry.

The silicone may include branch points such as

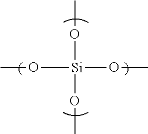

which is known as a “Q” group in silicone chemistry, or

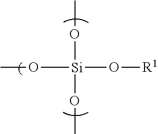

which is known as “T” group in silicone chemistry.

As used herein, the term “hydrocarbyl” denotes a univalent group formed by removing a hydrogen atom from a hydrocarbon (e.g., alkyl groups, such as ethyl, or aryl groups, such as phenyl). In one or more embodiments, a siloxane monomer residue can be any dialkyl, diaryl, dialkaryl, or diaralkyl siloxane, having the same or differing alkyl, aryl, alkaryl, or aralkyl moieties. In an embodiment, each of R¹ and R² is independently a C₁ to C₂₀, C₁ to C₁₂, or C₁ to C₆ alkyl (e.g., methyl, ethyl, propyl, butyl, etc.), aryl (e.g., phenyl), alkaryl, aralkyl, cycloalkyl (e.g., cyclopentyl), arylenyl, alkenyl, cycloalkenyl (e.g., cyclohexenyl), alkoxy (e.g., methoxy), etc., as well as combinations thereof. In various embodiments, R¹ and R² can have the same or a different number of carbon atoms. In various embodiments, the hydrocarbyl group for each of R¹ and R² is an alkyl group that is saturated and optionally straight-chain. Additionally, the alkyl group in such embodiments can be the same for each of R¹ and R² of a polymer chain. Non-limiting examples of alkyl groups suitable for use in R¹ and R² include methyl, ethyl, 1-propyl, 2-propyl, isobutyl, t-butyl, or combinations of two or more thereof.

Additionally, the siloxane polymer can contain various terminating groups as an R¹ and/or R² group, such as vinyl groups, hydroxyl groups, hydrides, isocyanate groups, epoxy groups, acid groups, halogen atoms, alkoxy groups, acyloxy groups, ketoximate groups, amino groups, amido groups, acid amido groups, amino-oxy groups, mercapto groups, alkenyloxy groups, alkoxyalkoxy groups, or aminoxy groups as well as combinations thereof. Additionally, a polymer composition can include a mixture of two or more siloxane polymers.

In some embodiments, a high molecular weight siloxane polymer can be proved by copolymerizing multiple siloxane polymers having a low weight average molecular weight (e.g., a molecular weight of less than 100,000 grams per mole) with polysiloxane linkers. In one particular embodiment, for instance, the resin may be formed by copolymerizing one or more low molecular siloxane polymer(s) with a linear polydiorganosiloxane linker, such as described in U.S. Pat. No. 6,072,012 to Juen, et al. A substantially linear polydiorganosiloxane linker may have the following general formula:

(R³₍₃₋ₚ₎R⁴ₚSiO_{1/2})(R³₂SiO_{2/2})ₓ((R³R⁴SiO_{2/2})(R³₂SiO_{2/2})ₓ)_{y}(R³₍₃₋ₚ₎R⁴ₚSiO_{1/2})

wherein,
each R³ is a monovalent group independently selected from the group consisting of alkyl, aryl, and arylalkyl groups;
each R⁴ is a monovalent group independently selected from the group consisting of hydrogen, hydroxyl, alkoxy, oximo, alkyloximo, and aryloximo groups, wherein at least two R⁵ groups are typically present in each molecule and bonded to different silicon atoms;
p is 0, 1, 2, or 3;
x ranges from 0 to 200, and in some embodiments, from 0 to 100; and
y ranges from 0 to 200, and in some embodiments, from 0 to 100.

In certain embodiments, the siloxane polymer may be provided in the form of a masterbatch that includes a carrier resin. The carrier resin may, for instance, constitute from about 0.05 wt. % to about 15 wt. %, in some embodiments from about 0.1 wt. % to about 10 wt. %, and in some embodiments, from about 0.5 wt. % to about 8 wt. % of the polymer composition. Any of a variety of carrier resins may be employed, such as polyolefins (ethylene polymer, propylene polymers, etc.), polyamides, etc. In one embodiment, for example, the carrier resin is an ethylene polymer. The ethylene polymer may be a copolymer of ethylene and an α-olefin, such as a C₃-C₂₀ α-olefin or C₃-C₁₂ α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %. The density of the ethylene polymer may vary depending on the type of polymer employed, but generally ranges from about 0.85 to about 0.96 grams per cubic centimeter (g/cm³). Polyethylene “plastomers”, for instance, may have a density in the range of from about 0.85 to about 0.91 g/cm³. Likewise, “linear low density polyethylene” (LLDPE) may have a density in the range of from about 0.91 to about 0.940 g/cm³; “low density polyethylene” (LDPE) may have a density in the range of from about to about 0.940 g/cm³; and “high density polyethylene” (HDPE) may have density in the range of from about 0.940 to about 0.960 g/cm³, such as determined in accordance with ASTM D792. Some non-limiting examples of high molecular weight siloxane polymer masterbatches that may be employed include, for instance, those available from Dow Corning under the trade designations MB50-001, MB50-002, MB50-313, MB50-314 and MB50-321.

If desired, an organosilane compound may also be employed in the polymer composition, such as in an amount of from about 0.1 to about 8 parts, in some embodiments from about 0.3 to about 5 parts, and in some embodiments, from about 0.5 to about 3 parts by weight per 100 parts by weight of the polyarylene sulfide(s). For example, organosilane compounds can constitute from about 0.01 wt. % to about 3 wt. %, in some embodiments from about 0.02 wt. % to about 2 wt. %, and in some embodiments, from about 0.05 to about 1 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵ —Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(p-aminoethyl)- γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

In certain embodiments, carbon nanostructures may also be distributed within the polymer matrix, such as in an amount of from about 0.1 wt. % to about 5 wt. %, in some embodiments from about 0.2 wt. % to about 3 wt. %, and in some embodiments, from about 0.4 wt. % to about 1.5 wt. % of the polymer composition. The carbon nanostructures may include carbon nanotubes that are optionally disposed on a substrate and arranged in a network having a web-like morphology in that at least a portion of the carbon nanotubes are branched, crosslinked, interdigitated, share common walls with one another, and so forth. It should be understood that every carbon nanotube does not necessarily have the foregoing structural features. Rather, the carbon nanotubes as a whole can possess one or more of these structural features. For example, in some embodiments, a portion of the carbon nanotubes may be branched, another portion of the carbon nanotubes may be crosslinked, and yet another portion of the carbon nanotubes may share common walls. Likewise, in some embodiments, at least a portion of the carbon nanotubes can be interdigitated with one another and/or with branched, crosslinked, or common-wall carbon nanotubes in the remainder of the carbon nanostructure.

The web-like morphology of the carbon nanostructure can result in a low bulk density. For example, as-produced carbon nanostructures can have an initial bulk density ranging between about 0.003 g/cm³ to about 0.015 g/cm³. Further consolidation and/or coating to produce a flake material or like morphology can raise the bulk density to a range between about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further altered by forming a coating on the carbon nanotubes and/or infiltrating the interior of the carbon nanostructure with various materials. Coating the carbon nanotubes and/or infiltrating the interior of the carbon nanostructure can further tailor the properties of the carbon nanostructure for use in various applications. Moreover, in some embodiments, forming a coating on the carbon nanotubes can desirably facilitate the handling of the carbon nanostructure. Further compaction can raise the bulk density to an upper limit of about 1 g/cm³, with chemical modifications to the carbon nanostructure raising the bulk density to an upper limit of about 1.2 g/cm³.

Various techniques may be employed to form the carbon nanostructures. In one embodiment, for instance, carbon nanotubes may be formed (e.g., grown, infused, etc.) on a substrate. Depending on the desired form of the nanostructures, the carbon nanotubes may be separated from the substrate or remain thereon. Examples of techniques for growing the nanotubes on a substrate are described, for example, in U.S. Patent Application Publication No. 2014/0093728, as well as U.S. Pat. Nos. 8,784,937; 9,005,755; 9,107,292; 9,241,433; and 9,447,259, all of which are incorporated herein in their entirety by reference thereto. Without intending to be limited by theory, it is believed that the use of a substrate can help form the complex, web-like morphology due to the ability of carbon nanotubes to grow at a rapid rate, such as on the order of several micrometers per second. The rapid carbon nanotube growth rate, coupled with the close proximity of the carbon nanotubes to one another, can confer the observed branching, crosslinking, and shared wall motifs to the carbon nanotubes.

Any of a variety of substrates may be employed during the synthesis of the carbon nanostructures, such as glass, inorganic materials, carbon materials, metals, polymers, etc. In some embodiments, the substrate can be a fiber material of a spoolable dimension (e.g., fabric, tow, fibers, yarn, sheet, tape, belt, etc.), which allows the formation of the carbon nanotubes to take place continuously on the substrate as it is conveyed from a first location to a second location. Such fiber materials may also provide additional functional benefits to the polymer composition when they remain attached to the carbon nanotube structure, such as enhancing strength and/or improving electrical conductivity. As used herein, the term “spoolable dimension” generally refers to fiber materials having at least one dimension that is not limited in length, allowing for the material to be stored on a spool or mandrel. Suitable fiber materials may, for instance, include materials made from glass (e.g., E-glass, S-glass, D-glass, etc.), carbon (e.g., graphite), ceramic, polymeric materials (e.g., polyamide, aramid, polyester, etc.), metals (e.g., steel, aluminum, copper, tungsten, etc.), carbides (e.g., silicon carbide), cellulosic materials, etc., as well as combinations thereof. Carbon fiber materials may, for instance, be suitable, particularly when it is desired to further increase the electrical conductivity of the polymer composition. When such fibers are employed as the substrate, the carbon nanotubes may be infused into the fibers. For example, the carbon nanotubes may be grown generally perpendicularly from the outer surface of fibers, thereby providing a radial coverage to each individual fiber. Carbon nanotubes may be grown in situ on fibers. For example, a fiber may be fed through a growth chamber maintained at a given temperature of about 500° C. to about 750° C. Carbon containing feed gas can then be introduced into the growth chamber, wherein carbon radicals dissociate and initiate formation of carbon nanotubes on the fiber.

Regardless of the nature of the substrate, a catalyst may be employed to help ensure the formation of the carbon nanostructures. Particularly suitable catalysts include, for instance, transition metal nanoparticles. Suitable transition metal nanoparticle catalysts can include any d-block transition metal or d-block transition metal salt. Non-limiting exemplary transition metal nanoparticles may include nickel, iron, cobalt, molybdenum, copper, platinum, gold, silver, etc., as well as salts and mixtures thereof. One mode for applying the catalyst to the substrate (e.g., infusion) can be through particle adsorption, such as through a liquid or colloidal catalyst solution. For example, a catalyst solution may be employed that contains the nanoparticles that include a transition metal or a salt thereof, such as an acetate, carbide, etc. In such embodiments, the transition metal salt can be converted into a zero-valent transition metal on the substrate through a thermal treatment. The transition metal nanoparticles may also be coated with an anti-adhesive coating that limits their adherence to the substrate and promote removal of the carbon nanostructure from the substrate following synthesis of the carbon nanostructure. In some embodiments, the carbon nanostructure can be removed from the substrate without substantially removing the transition metal nanoparticle catalyst.

The carbon nanotube structure may optionally be removed from the substrate. In such embodiments, known techniques may be employed for the removal of the carbon nanotubes, such as providing an anti-adhesive coating on the substrate, providing an anti-adhesive coating on a transition metal nanoparticle catalyst employed in synthesizing the carbon nanostructure, providing a transition metal nanoparticle catalyst with a counter ion that etches the substrate, thereby weakening the adherence of the carbon nanostructure to the substrate, and/or conducting an etching operation after carbon nanostructure synthesis is complete to weaken adherence of the carbon nanostructure to the substrate. In one embodiment, for instance, a high pressure liquid or gas may be employed to separate the carbon nanostructures from the substrate. Thereafter, contaminants derived from the substrate (e.g., fragmented substrate) may be separated from the carbon nanostructures, such as by using cyclone filtering, density separation, size-based separation, etc. The nanostructures may then be collected with air or from a liquid medium with the aid of a filter medium, and thereafter isolated from the filter medium. Of course, in other embodiments, the carbon nanostructures are not removed from the substrate. This may be particularly desirable when the substrate itself can provide other functional benefits to the polymer composition.

In some embodiments, at least a portion of the carbon nanotubes can be aligned substantially parallel to one another in the carbon nanostructure. Without being bound by any theory, it is believed that the formation of carbon nanotubes on a substrate under the carbon nanostructure growth conditions described herein results in substantially vertical growth of at least a majority of the carbon nanotubes from the substrate surface. Even after any optional removal of the carbon nanostructure from the substrate, the substantially parallel alignment of the carbon nanotubes can be maintained. In fact, the structural features of branching, crosslinking, and shared carbon nanotube walls can sometimes become more prevalent at locations on the carbon nanotubes that are further removed from the substrate. Regardless, because the carbon nanostructures can be obtained with the carbon nanotubes aligned substantially parallel with respect to one another, they can be manipulated more readily with respect to alignment than can individual carbon nanotubes, which may need to undergo further processing to bring the carbon nanotubes into parallel alignment. Parallel alignment of carbon nanotubes can improve electrical conductivity and enhance mechanical strength in the direction of carbon nanotube alignment.

A coating may also be applied to the carbon nanotubes of the carbon nanostructure before or after removal of the carbon nanostructure from the substrate. Application of a coating before removal of the carbon nanostructure from the substrate can, for example, protect the carbon nanotubes during the removal process or facilitate the removal process. In other embodiments, a coating can be applied to the carbon nanotubes of the carbon nanostructure after removal of the carbon nanostructure from the substrate. Application of a coating to the carbon nanotubes of the carbon nanostructure after its removal from the substrate can desirably facilitate handling and storage of the carbon nanostructure. In particular, coating the carbon nanostructure can desirably promote the consolidation or densification of the carbon nanostructure. Higher densities can desirably facilitate the processibility of the carbon nanostructure. The coating can be covalently bonded to the carbon nanotubes of the carbon nanostructure. In some embodiments, the carbon nanotubes can be functionalized before or after removal of the carbon nanostructure from the substrate so as to provide suitable reactive functional groups for forming such a coating. Suitable processes for functionalizing the carbon nanotubes of a carbon nanostructure are usually similar to those that can be used to functionalize individual carbon nanotubes and will be known by a person having ordinary skill in the art. In other embodiments, the coating can be non-covalently bonded to the carbon nanotubes of the carbon nanostructure. That is, in such embodiments, the coating can be physically disposed on the carbon nanotubes.

If desired, the coating on the carbon nanotubes can be a polymer coating. Suitable polymer coatings are not believed to be particularly limited and can include polymers such as, for example, an epoxy, polyester, vinylester polymer, polyetherimide, polyetherketoneketone, polyphthalamide, polyetherketone, polyetheretherketone, polyimide, phenol-formaldehyde polymer, bismaleimide polymer, acrylonitrile-butadiene styrene (ABS) polymer, polycarbonate, polyethyleneimine, polyurethane, polyvinyl chloride, polystyrene, polyolefin, polypropylene, polyethylene, polytetrafluoroethylene, and any combination thereof. In addition to polymer coatings, other types of coatings can also be present, such as metal coatings and ceramic coatings. Another additive material may also be present in at least the interstitial space between the carbon nanotubes of the carbon nanostructure (i.e., on the interior of the carbon nanostructure). The additive material can be used alone or in combination with a coating on the carbon nanotubes of the carbon nanostructure. When used in combination with a coating, the additive material can also be located on the exterior of the carbon nanostructure within the coating, in addition to being located within the interstitial space of the carbon nanostructure. Introduction of an additive material within the interstitial space of the carbon nanostructure or elsewhere within the carbon nanostructure can result in further modification of the properties of the carbon nanostructure. The nanostructures may also contain some transition metal nanoparticles employed as a catalyst during the synthesis of the nanostructures. The transition metal nanoparticles can be coated with an anti-adhesive coating that limits their adherence to a substrate or the carbon nanostructure to a substrate. In various embodiments, the anti-adhesive coating can be carried along with the transition metal nanoparticles as the carbon nanostructure and the transition metal nanoparticles are removed from the substrate. In other embodiments, the anti-adhesive coating can be removed from the transition metal nanoparticles before or after they are incorporated into the carbon nanostructure. In still other embodiments, the transition metal nanoparticles can initially be incorporated into the carbon nanostructure and then subsequently removed. For example, in some embodiments, at least a portion of the transition metal nanoparticles can be removed from the carbon nanostructure by treating the carbon nanostructure with a mineral acid. The nanostructures may also contain a substrate.

The carbon nanostructures may be provided in a variety of different forms, such as flakes, granules, pellets, fibers, or in other forms of loose particulate material. In certain embodiments, it may be desirable to employ carbon nanostructures that are in the form of a flake material, which includes discrete particles having finite dimensions. A flake structure can have a first dimension that is in a range from about 1 nm to about 35 μm thick, particularly about 1 nm to about 500 nm thick, including any value in between and any fraction thereof. The flake structure can have a second dimension that is in a range from about 1 micron to about 750 microns tall, including any value in between and any fraction thereof. The flake structure can also have a third dimension that is only limited in size based on the length of the substrate upon which the carbon nanostructure is initially formed. For example, in some embodiments, the process for growing a carbon nanostructure on a substrate can take place on a tow or roving of a fiber-based material of spoolable dimensions. The carbon nanostructure growth process can be continuous, and the carbon nanostructure can extend the entire length of a spool of fiber. Thus, in some embodiments, the third dimension can be in a range from about 1 m to about 10,000 m wide. Again, the third dimension can be very long because it represents the dimension that runs along the axis of the substrate upon which the carbon nanostructure is formed. The third dimension 130 can also be decreased to any desired length less than 1 μm. For example, in some embodiments, third dimension 130 can be on the order of about 1 μm to about 10 μm, or about 10 μm to about 100 μm, or about 100 μm to about 500 μm, or about 500 microns to about 1 cm, up to any desired length, including any amount between the recited ranges and any fractions thereof. Since the substrate upon which the carbon nanostructure is formed can be quite large, exceptionally high molecular weight carbon nanostructures can be produced by forming the polymer-like morphology of the carbon nanostructure as a continuous layer on a suitable substrate.

The flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some embodiments, the upper end of the molecular weight range can be even higher, including about 200,000 g/mol, about 500,000 g/mol, or about 1,000,000 g/mol. The higher molecular weights can be associated with carbon nanostructures that are dimensionally long. In various embodiments, the molecular weight can also be a function of the predominant carbon nanotube diameter and number of carbon nanotube walls present within the carbon nanostructure. In some embodiments, the carbon nanostructure can have a crosslinking density ranging between about 2 mol/cm³ to about 80 mol/cm³. The crosslinking density can be a function of the carbon nanostructure growth density on the surface of the substrate as well as the carbon nanostructure growth conditions.

As used herein, the “carbon nanotubes” employed in the nanostructures are generally any number of cylindrically-shaped allotropes of carbon of the fullerene family and include single-walled carbon nanotubes (SWNTs), double-walled carbon nanotubes (DWNTs), multi-walled carbon nanotubes (MWNTs), etc., as well as combinations thereof. The carbon nanotubes can be capped by a fullerene-like structure or open-ended, and may include those that encapsulate other materials. SWCNTs can be thought of as an allotrope of sp2-hybridized carbon similar to fullerenes. The structure is a cylindrical tube including six-membered carbon rings. Analogous MWCNTs, on the other hand, have several tubes in concentric cylinders. The number of these concentric walls may vary, such as from 2 to 25 or more. Typically, the diameter of MWNTs may be 10 nm or more, in comparison to 0.7 to 2.0 nm for typical SWNTs. It is typically desired that the carbon nanostructures employed in the polymer composition are formed from MWCNTs, such as those having at least two coaxial carbon nanotubes. The number of walls present, as determined, for example, by transmission electron microscopy (TEM), at a magnification sufficient for analyzing the number of wall in a particular case, can be within the range of from 2 to 30, in some embodiments, from 4 to 28, in some embodiments from 5 to 26, and in some embodiments, from 6 to 24. Carbon nanotubes present in or derived from the carbon nanostructures typically has a typical diameter of 100 nanometers or less, in some embodiments from about 5 to about 90 nanometers, and in some embodiments, from about 10 to about 30 nanometers. The carbon nanotubes may also have a length of about 2 micrometers or more, in some embodiments from about 2 to about 10 micrometers, and in some embodiments, from about 2.5 to about 5 micrometers. The aspect ratio of the carbon nanotubes may also be relatively high, such as from about 200 to about 1,000, in some embodiments from about 300 to about 900, and in some embodiments, from about 400 to about 800.

In certain embodiments, it may also be desirable to employ a dielectric filler in the polymer composition. When employed, the dielectric filler is typically present in an amount of from about 10 wt. % to about 60 wt. %, in some embodiments from about 20 wt. % to about 55 wt. %, and in some embodiments, from about 30 wt. % to about 50 wt. % of the composition. In certain embodiments, it may be desirable to selectively control the electrical properties of the dielectric filler to help achieve the desired results. For example, the dielectric constant of the material may be about 20 or more, ins some embodiments about 40 or more, and in some embodiments, about 50 more as determined at a frequency of 1 MHz. High dielectric constant materials may be employed in certain embodiments, such as from about 1,000 to about 15,000, in some embodiments from about 3,500 to about 12,000, and in some embodiments, from about 5,000 to about 10,000, as determined at a frequency of 1 MHz. In other embodiments, mid-range dielectric constant materials may be employed, such as from about 20 to about 200, in some embodiments from about 40 to about 150, and in some embodiments, from about 50 to about 100, as determined at a frequency of 1 MHz. The volume resistivity of the dielectric filler may likewise range from about 1×10¹¹ to about 1×10²⁰ ohm-cm, in some embodiments from about 1×10¹² to about 1×10¹⁹ ohm-cm, and in some embodiments, from about 1×10¹³ to about 1×10¹⁸ ohm-cm, such as determined at a temperature of about 20° C. in accordance with ASTM D257-14. The desired properties may be accomplished by selecting a single material having the target volume dielectric constant and/or volume resistivity, or by blending multiple materials together (e.g., insulative and electrically conductive) so that the resulting blend has the desired properties.

Particularly suitable inorganic oxide dielectric materials may include, for instance, ferroelectric and/or paraelectric materials. Examples of suitable ferroelectric materials include, for instance, barium titanate (BaTiO₃), strontium titanate (SrTiO₃), calcium titanate (CaTiO₃), magnesium titanate (MgTiO₃), strontium barium titanate (SrBaTiO₃), sodium barium niobate (NaBa₂Nb₅O₁₅), potassium barium niobate (KBa₂Nb₅O₁₅), calcium zirconate (CaZrO₃), titanite (CaTiSiO₅), as well as combinations thereof. Examples of suitable paraelectric materials likewise include, for instance, titanium dioxide (TiO₂), tantalum pentoxide (Ta₂O₅), hafnium dioxide (HfO₂), niobium pentoxide (Nb₂O₅), alumina (Al₂O₃), zinc oxide (ZnO), etc., as well as combinations thereof. Particularly suitable inorganic oxide materials are particles that include TiO₂, BaTiO₃, SrTiO₃, CaTiO₃, MgTiO₃, BaSrTi₂O₆, and ZnO. Of course, other types of inorganic oxide materials (e.g., mica) may also be employed as a dielectric filler.

In one particular embodiment, titanium dioxide (TiO₂) particles may be employed in the polymer composition as a dielectric filler. The particles may be in the rutile or anatase crystalline form, although rutile is particularly suitable due to its higher density and tint strength. Rutile titanium dioxide is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Preferably, the titanium dioxide particles may be in the rutile crystalline form and made using the chloride process. The titanium dioxide particles may be substantially pure titanium dioxide or may contain other metal oxides, such as silica, alumina, zirconia, etc. Other metal oxides may be incorporated into the particles, for example, by co-oxidizing or co-precipitating titanium compounds with other metal compounds, such as metal halides of silicon, aluminum and zirconium. If co-oxidized or co-precipitated metals are present, they are typically present in an amount 0.1 to 5 wt. % as the metal oxide based on the weight of the titanium dioxide particles. When alumina is incorporated into the particles by co-oxidation of aluminum halide (e.g., aluminum chloride), alumina is typically present in an amount from about 0.5 to about 5 wt. %, and in some embodiments, from about 0.5 to about 1.5 wt. % based on the total weight of the particles. The titanium dioxide particles may also be coated with an inorganic oxide (e.g., alumina), organic compound, or a combination thereof. Such coatings may be applied using a surface wet treatment technique and/or oxidation technique as are known by those skilled in the art. In one embodiment, for example, the titanium dioxide particles may contain a coating that includes alumina, such as in an amount of from about 0.5 to about 5 wt. %, and in some embodiments, from about 1 to about 3 wt. % of the coating.

The shape and size of the dielectric fillers are not particularly limited and may include particles, fine powders, fibers, whiskers, tetrapod, plates, etc. In one embodiment, for instance, the dielectric filler may include particles having an average diameter of from about 0.01 to about 50 micrometers, in some embodiments from about 0.05 to about 10 micrometers, and in some embodiments, from about 0.1 to about 1 micrometer.

Another suitable dielectric filler may include a polyhedral silsesquioxane (“POSS”). Polyhedral silsesquioxanes have the generic formula (RSiO_{1.5})ₙ wherein R is an organic moiety and n is 6, 8, 10, 12, or higher. These molecules have rigid, thermally stable silicon-oxygen frameworks with an oxygen to silicon ratio of 1.5. One particular example of an Si₈ POSS structure is illustrated below:

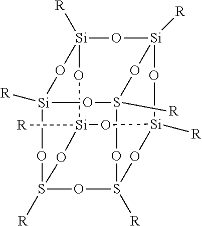

Functionalized POSS monomers may also be employed, such as by corner-capping an incompletely condensed POSS containing trisilanol groups with a substituted trichlorosilane. For example, the trisilanol functionality of R₇T₄D₃(OH)₃ (wherein R is a hydrocarbon group) can be reacted with Cl₃Si—Y to produce the fully condensed POSS monomer R₇T₈Y. In the following structure, T is SiO_{1.5}, and Y is an organic group comprising a functional group:

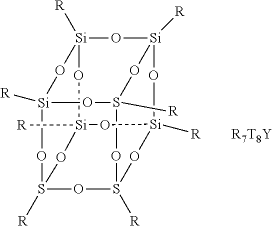

Through variation of the Y group on the silane, a variety of functional groups can be placed off the corner of the POSS framework, including but not limited to halide, alcohol, amine, hydride, isocyanate, acid, acid chloride, silanols, silane, acrylate, methacrylate, olefin, and epoxide.

Further examples of suitable POSS monomers include those of the general formula Rₙ₋ₘTₙYₘ wherein R is a hydrocarbon; n is 6, 8, 10, 12 or higher; m is 1 to n; T is SiO_{1.5}, and Y is an organic group comprising a functional group, wherein the functional group includes, for example, halide, alcohol, amine, isocyanate, acid, acid chloride, silanols, silane, acrylate, methacrylate, olefin, and epoxide. A suitable POSS monomer has, for example, an n of 8; m of 1, 2, 3, 4, 5, 6, 7, or 8; R of C₁-C₂₄ straight, branched, or cyclic alkyl, C₁-C₂₄ aromatic, alkylaryl, or arylakyl, wherein the alkyl, or aromatic is optionally substituted with C₁-C₆ alkyl, halo, C₁-C₆ alkoxy, C₁-C₆ perhaloalkyl, and so forth. Another suitable POSS monomer includes those of the general formula R₇T₄D₃(OY)₃:

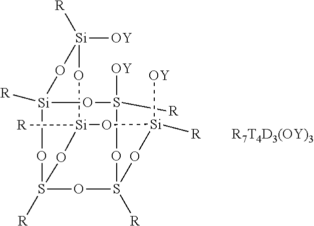

wherein R and Y are as defined previously for the R₇T₈Y POSS monomer.

Suitable functional groups are epoxies, esters and acrylate (—X—OC(O)CH═CH₂) and methacrylate (—X—OC(O)CH(CH₃)═CH₂) groups, wherein X is a divalent linking group having 1 to about 36 carbons, such as methylene, ethylene, propylene, isopropylene, butylene, isobutylene, phenylene, and the like. X may also be substituted with functional groups such as ether (e.g., —CH₂CH₂OCH₂CH₂—), as long as such functional groups do not interfere with formation or use of the POSS. X may be propylene, isobutylene, or —OSi(CH₃)₂CH₂CH₂CH₂—. One, all, or an intermediate number of the covalently bound groups may be acrylate or methacrylate groups (hereinafter (meth)acrylate). The linking groups X are suitable for use with other functional groups. Other POSS structures include, for example T₆, T₈, T₁₀, or T₁₂ structures functionalized with alkoxysilanes such as diethoxymethylsilylethyl, diethoxymethylsilylpropyl, ethoxydimethylsilylethyl, ethoxydimethylsilylpropyl, triethoxysilylethyl, etc.; with styrene, such as styrenyl (—C₆H₅CH═CH—), styryl (—C₆H₄CH═CH₂), etc.; with olefins such as allyl, —OSi(CH₃)₂CH₂CH═CH₂, cyclohexenylethyl, —OSi(CH₃)₂CH═CH₂, etc., with epoxies, such as 4-propyl-1,2-epoxycyclohexyl, 3-propoxy, glycidyl, etc., with chlorosilanes such as chlorosilylethyl, dichlorosilylethyl, trichlorosilylethyl, and the like; with amines such as aminopropyl, aminoethylaminopropyl, and the like; with alcohols and phenols such as —OSi(CH₃)₂CH₂CH₂CH₂OC(CH₂CH₃)₂(CH₂CH₂OH), 4-propylene-trans-1,2-cyclohexanediol, etc.; with phosphines such as diphenylphosphinoethyl, diphenylphosphinopropyl, etc.; with norbornenyls such as norbornenylethyl; with nitriles such as cyanoethyl, cyanopropyl, —OSi(CH₃)₂CH₂CH₂CH₂CN, etc.; with isocyanates such as isocyanatopropyl, —OSi(CH₃)₂CH₂CH₂CH₂CNO, etc., with halides such as 3-chloropropyl, chlorobenzyl (—C₆H₄CH₂Cl), chlorobenzylethyl, 4-chlorophenyl, trifluoropropyl (including a T₈ cube with eight trifluoropropyl substitutions), etc.; and with esters, such as ethyl undecanoat-1-yl and methyl propionat-1-yl, etc.

Still other components that can be included in the composition may include, for instance, pigments (e.g., black pigments), antioxidants, stabilizers, crosslinking agents, lubricants, flow promoters, and other materials added to enhance properties and processability.

### II. Melt Processing

The manner in which the polyarylene sulfide, mineral particles, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The melting temperature of the polymer composition may also range from 140° C. to about 380° C., in some embodiments from about 200° C. to about 360° C., in some embodiments from about 250° C. to about 320° C., and in some embodiments, from about 260° C. to about 300° C. The melting and crystallization temperatures may be determined as is well known in the art using differential scanning calorimetry in accordance with ISO Test No. 11357-3:2018.

### III. Formed Component

A variety of different components may be formed using the polymer composition described herein. Moreover, a component may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

The unique properties of the polymer composition can also allow it to be integrally formed with a metal component having a vastly different thermal coefficient of expansion. Thus, if desired, the polymer composition may be employed in a composite structure that contains a metal component that is integrally formed and in contact with a resinous component that includes the polymer composition of the present invention. This may be accomplished using a variety of techniques, such as by an insert molding process in which the polymer composition is molded (e.g., injection molded) onto a portion or the entire surface of the metal component. The metal component may contain any of a variety of different metals, such as aluminum, stainless steel, magnesium, nickel, chromium, copper, titanium, and alloys thereof. Due to its unique properties, the polymer composition can adhere to the metal component by flowing within and/or around surface indentations or pores of the metal component. To improve adhesion, the metal component may optionally be pretreated to increase the degree of surface indentations and surface area. This may be accomplished using mechanical techniques (e.g., sandblasting, grinding, flaring, punching, molding, etc.) and/or chemical techniques (e.g., etching, anodic oxidation, etc.). In addition to pretreating the surface, the metal component may also be preheated at a temperature close to, but below the melt temperature of the polymer composition. This may be accomplished using a variety of techniques, such as contact heating, radiant gas heating, infrared heating, convection or forced convection air heating, induction heating, microwave heating or combinations thereof. In any event, the polymer composition is generally injected into a mold that contains the optionally preheated metal component.

### IV. Product Applications

The polymer composition may be employed in a wide variety of product applications, but is particularly beneficial for use in components of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. For example, the component may include a bobbin, busbar, current sensor, inverter filter, electrical connector, a brushless direct current motor, a guide ring, a battery cell sealing ring, end cap for a motor, pump housing, or a combination thereof. Referring to FIG. 1, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells.

In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 36 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

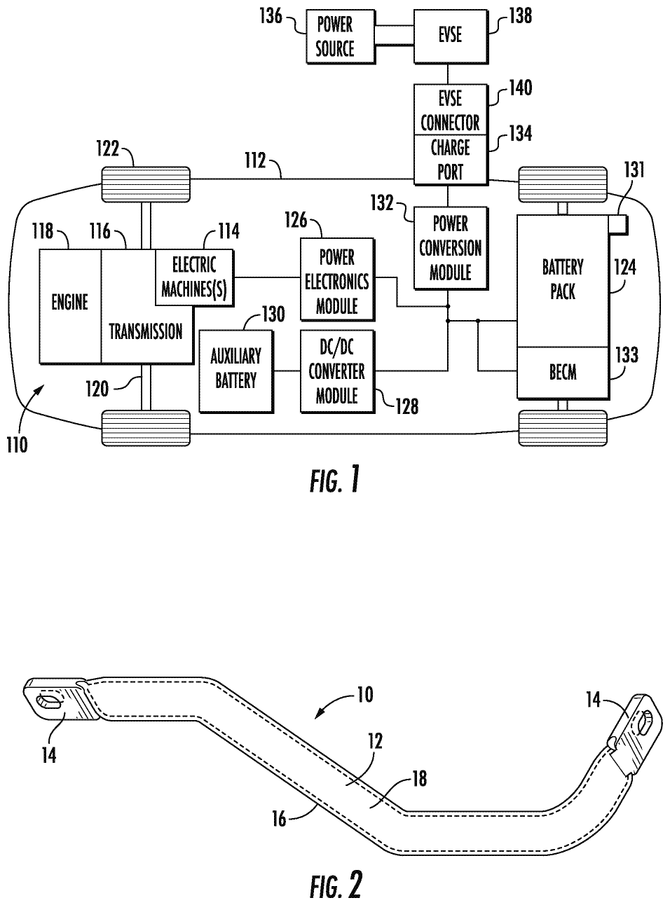

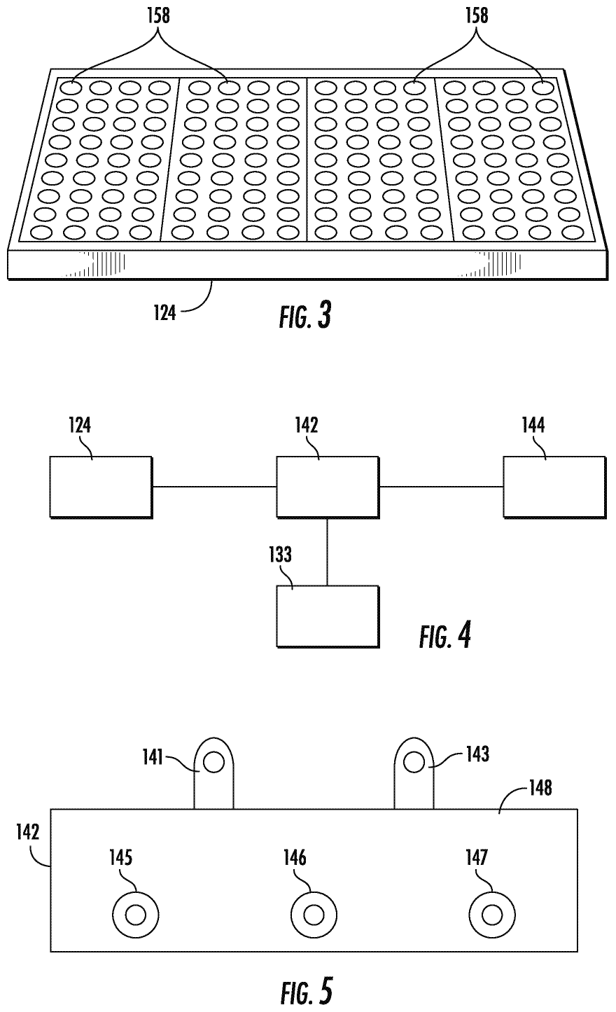

The polymer composition described herein can be included in various components of an electric vehicle as illustrated in FIG. 1. For instance, a busbar, one example of which is illustrated in FIG. 2, may be used to electrically connect individual cells of the battery assembly 124. Referring to FIG. 3, for example, the battery assembly 124 can include a number of battery cells 158. The battery cells 158 may be stacked side-by-side to construct a grouping of battery cells, sometimes referred to as a battery array. In one embodiment, the battery cells 158 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. Each battery cell 158 includes a positive terminal (designated by the symbol (+)) and a negative terminal (designed by the symbol (−)). The battery cells 158 are arranged such that each battery cell 158 terminal is disposed adjacent to a terminal of an adjacent battery cell 158 having an opposite polarity. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle. For example, some embodiments may use the 6831 NCR 18650 battery cell from Panasonic®, or some variation on the 18650 form-factor of 6.5 cm×1.8 cm and approximately 45 g.

The manner in which a busbar connects to individual battery cells of a battery assembly 124, such as shown in FIG. 3, may vary as is known in the art. Referring to FIG. 2, one embodiment of a busbar 10 is shown that includes a conductive body 12. The body 12 includes a conductive material 18, such as copper, aluminum, aluminum alloy, etc., and can generally be in the form of a solid bar, hollow tube, and so forth. The busbar 10 includes a connector portion 14 at either end that is configured to mate with respective terminations of two or more batteries. An insulative portion 16 (e.g., coating or molded material) that includes the polymer composition as described herein may cover a portion of the conductive material of the body 12. To form the busbar 10, the insulative portion 16 can be applied to the surface of the conductive material 18. For instance, a bar or tube of the conductive material 18 can be inserted into a pre-formed tube of the insulating coating 16, e.g., an extruded tube sized and cut to the correct proportions, following which the busbar 10 can be shaped to any suitable form. In another embodiment, the insulating coating can be applied to the surface of the conductive material 18 in the melt, and can solidify on the surface of the conductive material in the applied areas.

Of course, a busbar may be provided in any suitable shape and size. For instance, a busbar may be used as a template for placing the individual battery cells so that they are uniform in each battery assembly manufactured. In such an embodiment, a busbar may hold individual batteries of a battery assembly 124 in place during the manufacturing process and thermal padding or injection-housings, which can be formed of a polymer composition as described herein, can be added without causing the individual battery cells to shift out of position.

Apart from busbars, other components may also employ the polymer composition of the present invention. For instance, FIG. 4 presents a block diagram of battery electronics of an electric vehicle 112. The illustrated battery electronics system includes a battery assembly 124 and a current sensor 142. As shown, current sensor 142 is connected between battery assembly 124 and load/source 144. The current sensor 142 can be configured to measure the current flowing from the battery assembly 124 to the load/source 144 when load/source 144 is a load such as one or more electric machines 114. Likewise, current sensor 142 can be configured to measure the current flowing to battery assembly 124 from load/source 144 when the load/source 144 is a source such as an external power source 136. The (BECM) 133 can be configured to power current sensor 142 to enable its operation. The BECM 133 can further be configured to read an output generated by current sensor 142 which is indicative of the current flowing between battery assembly 124 and load/source 144.

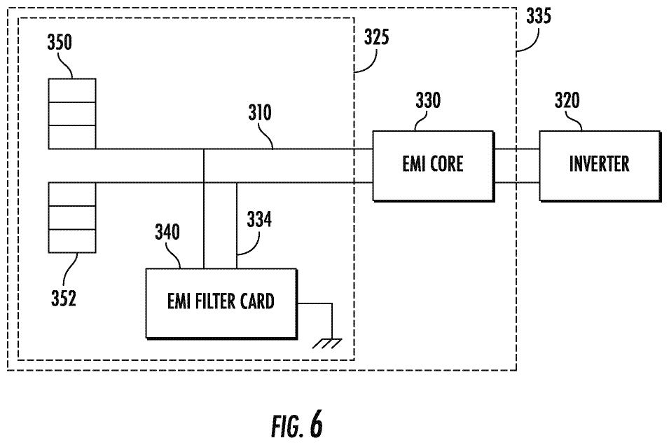

FIG. 5 illustrates one embodiment of a current sensor 142. A current sensor 142 can include a current in port 141 and a current out port 143 as well as standard ground 145, voltage at common collector (VCC) 146, and output port(s) 147. The current sensor 142 can also include a housing 148 that includes the polymer composition as described that can house other components of the current sensor 142, e.g., resistors, capacitors, converters, processing chips, etc.

Another component of an electric vehicle as may incorporate the polymer compositions as described is an inverter system, one exemplary embodiment of which is illustrated in FIG. 6. The system includes an inverter module 320 and an interconnection system 335. The interconnection system 335 includes an Electromagnetic Interference (EMI) core 330 and an EMI filter apparatus 325. The inverter module 320 is coupled to the interconnection system 335 by a pair of bus bars 310. The EMI core 330 is located between the EMI filter apparatus 325 and the inverter module 320 and is in communication with the bus bars 310. The EMI filter apparatus 325 includes an EMI filter card 340 and a pair of bolts 350, 352 which include a positive terminal (+) bolt 350 and a negative terminal (−) bolt 352 for coupling to a power source, e.g., the battery assembly 124. The EMI core 330 is coupled to the bolts 350, 352 by the bus bars 310. The EMI filter card 340 is also coupled between ground and the bus bars 310 via a pair of wires 334. An inverter module 320 includes a number of transistors (not shown). Transistors in an inverter module 320 switch on and off relatively rapidly (e.g., 5 to 20 kHz). This switching tends to generate electrical switching noise. The electrical switching noise should ideally be contained inside the inverter module 320 and prevented from entering the rest of the electrical system to prevent interference with other electrical components in the vehicle.

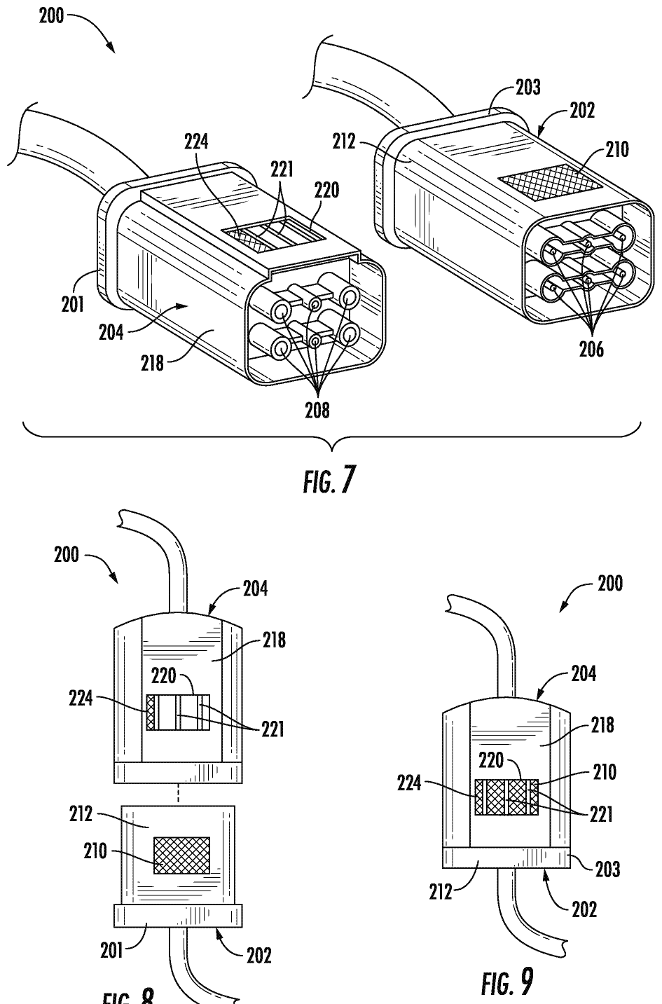

An inverter system can include several components that can incorporate a polymer composition as disclosed including, without limitation, the EMI filter apparatus 325, e.g., as a housing and/or internal support structures, an EMI filter card 340, the bus bars 310, as well as connectors employed within the system. For example, an electrical connector that includes the polymer composition as described herein may be employed in an inverter system as in FIG. 7 or within another portion of an electric vehicle. An electrical connector can in general include a first connector portion that contains at least one electrical contact and an insulating member that surrounds at least a portion of the connector portion. The insulating member may contain the polymer composition of the present invention. The first connector portion may be configured to mate with an opposing second connector portion that contains a receptacle for receiving the electrical contact. In such embodiments, the second connector portion may contain at least one receptacle configured to receive the electrical contact of the first connector portion and an insulating member that surrounds at least a portion of the second connector portion. The insulating member of the second connector portion may also contain the polymer composition of the present invention.

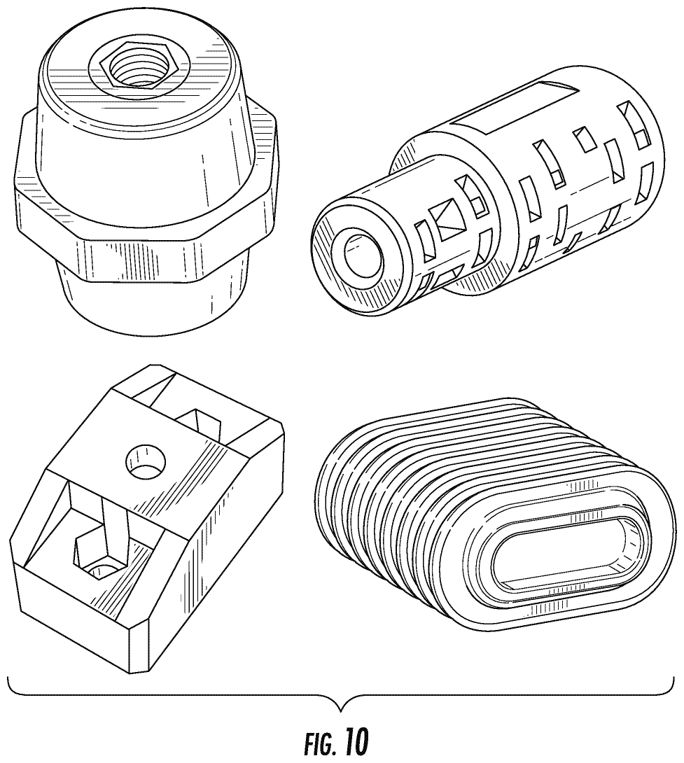

Referring to FIG. 7, FIG. 8, and FIG. 9, one particular embodiment of a connector 200 is shown for use in an electric vehicle, e.g., in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first insulator member 212 may extend from a base 203 of the first connecting portion 202 to surround the pins 206, and similarly, a second insulator member 218 may extend from a base 201 of the second connecting portion 204 to surround the receptacles 208. In certain cases, the periphery of the first insulator member 212 may extend beyond an end of the electrical pins 203 and the periphery of the second insulator member 218 may extend beyond an end of the receptacles 208. The base 203 and/or the first insulator member 212 of the first connector portion 202, as well as the base 201 and/or the second insulator member 218 of the second connector portion 204, may be formed from the polymer composition of the present invention.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

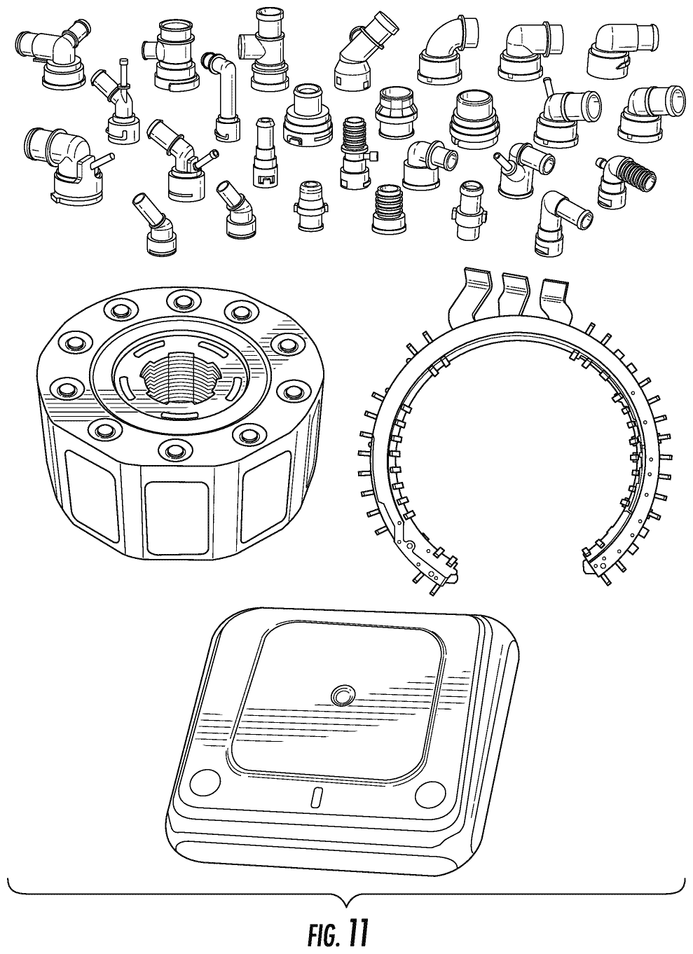

FIG. 10 and FIG. 11 illustrate yet other examples of components that may employ the polymer composition of the present invention, such as spacers, connectors, insulators and supports as shown in FIG. 10 and that can be formed from the polymer composition. Components as may incorporate a polymer composition illustrated in FIG. 11 include quick connects, tees, and interconnectors, a plurality of which are illustrated at the top of FIG. 11; brushless direct current motors (middle left of FIG. 11), e.g., sealing rings, end caps, housings, supports, etc. of a motor; guide rails (middle right of FIG. 11, also illustrating additional examples of busbars in the image); and battery sealing rings (bottom of FIG. 11).

Systems that can employ the polymer composition of the present invention are in no way limited to only electrical systems. For example, a thermal management system can also beneficially incorporate the polymer composition. A thermal management system of an electric vehicle can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

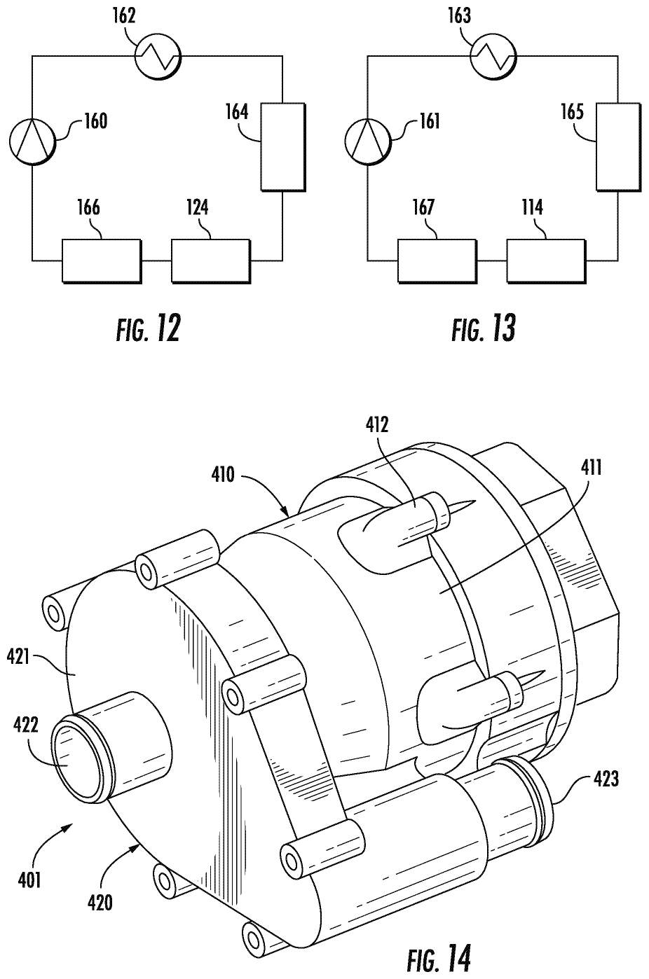

By way of example, FIG. 12 illustrates a first temperature control loop and FIG. 13 illustrates a second temperature control loop as may be found in electric vehicles, each of which designed for different subsystems and each of which including one or more components that can employ a polymer compositions of the invention. By way of example, a first temperature control loop in a typical electric vehicle (FIG. 12) can include a heat transfer medium (e.g., water) that is pumped through the loop via a suitable pump 160, e.g., an electric water pump, and cooled via heat transfer with a refrigerant in a heat exchanger 162 (e.g., an energy storage system (ESS) heat exchanger) as well as a radiator/reservoir 164. Additionally, the loop can include a heater 166 e.g., a positive temperature coefficient (PTC) heater, which can ensure that the temperature of the system can be maintained within its preferred operating range regardless of the ambient temperature, and the battery assembly 124. A second temperature control loop (FIG. 13) can also include a heat transfer medium that can be the same or differ from the heat transfer medium of another subsystem. The heat transfer medium of the second temperature control loop can be pumped through the loop with a suitable pump 161, a heat exchanger 162, and a radiator reservoir 165. A high temperature control loop can be utilized in cooling the power electronics 167 as well as the electric machines 114 of the vehicle.

One example of a component of a heat management system as may incorporate the polymer composition of the invention is a coolant pump, e.g., an electric water pump, an example of which is illustrated in FIG. 14. As shown, the electric water pump 401 includes an electric motor 410 as a drive source and a hydraulic portion 420 for generating coolant suction and discharge forces. The motor 410 and associated components are retained with in the motor housing 411. The hydraulic portion 420 includes a volute casing 421 that generally includes a spiral flow space, an inlet 422, and outlet 423, and an impeller (not shown) rotated by the electric motor 410. The pump 401 has an interface including a mechanical seal (not shown), for sealing and separating the water flow space and the motor chamber. Generally, a mounting portion 412 is provided on the motor housing 411 to mount the pump 401 in the vehicle. Components of an electric pump 401 such as housings, casings, interfaces, etc. can incorporate a polymer composition of the invention.

### Test Methods

Thermal Conductivity: As is known in the art, the thermal diffusivity of a sample in various directions (in-plane, cross-plane, through-plane) may be initially determined based on the laser flash method in accordance with ASTM E1461-13(2022). The thermal conductivity (in-plane, cross-plane, and through-plane) may then be calculated according to the following formula: Thermal Conductivity (W/m*K)=Cp*ρ*α, where Cp is the specific heat capacity (Ws/kgK) of the sample, ρ is the intrinsic density (kg/m³) of the sample as determined in accordance with ASTM D792-20, and α is the measured thermal diffusivity (m²/s).

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Dielectric Constant (“Dk”) and Dissipation Factor (“Df”): The dielectric constant (or relative static permittivity) and dissipation factor are determined using a known split-post dielectric resonator technique, such as described in Baker-Jarvis, et al., IEEE Trans. on Dielectric and Electrical Insulation, 5(4), p. 571 (1998) and Krupka, et al., Proc. 7^{th} International Conference on Dielectric Materials: Measurements and Applications, IEEE Conference Publication No. 430 (September 1996). More particularly, a plaque sample having a size of 80 mm×90 mm×3 mm or a disc sample having a 4-inch and 3-mm thickness may be inserted between two fixed dielectric resonators. The resonator measured the permittivity component in the plane of the specimen. Five (5) samples are tested and the average value is recorded. The split-post resonator can be used to make dielectric measurements in the low gigahertz region, such as 2 GHz or 10 GHz.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for |
| | more than 10 seconds after either test flame application. |
| | Total flaming combustion time must not exceed 50 seconds |
| | for each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for |
| | longer than 30 seconds after removal of the test flame. |
| V-1 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 60 seconds after removal of the test flame. |
| V-2 | Specimens must not burn with flaming combustion for more than |
| | 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

### COMPARATIVE EXAMPLES 1-2

Two (2) comparative resin samples are formed from the components listed in the table below.

| | |
|---|---|
| Comp. Ex. 1 | Comp. Ex. 2 |

| | wt. % | parts | wt. % | parts |
|---|---|---|---|---|
| PPS | 44.7 | 100 | 58.5 | 100 |
| Mica | 30 | 67 | — | — |
| Boron Nitride | — | | 16.0 | 27 |
| Glass Fibers | 20.0 | 45 | 20.0 | 34 |
| Lubricant | 0.3 | 1 | 0.3 | 1 |
| Black Pigment | 5.0 | 11 | 5.0 | 9 |

### EXAMPLES 1-7

Seven (7) resin samples are formed from the components listed in the tables below.

| | Ex. 1 | Ex. 2 | Ex. 3 | Ex. 4 | Ex. 5 | Ex. 6 | Ex. 7 |
|---|---|---|---|---|---|---|---|
| | (wt. %) | (wt. %) | (wt. %) | (wt. %) | (wt. %) | (wt. %) | (wt. %) |
| PPS | 74.7 | 54.7 | 34.7 | 49.7 | 29.7 | 54.7 | 74.7 |
| Talc | 20.0 | 40.0 | 60.0 | 45.0 | 55.0 | — | — |
| Nylgos ® 8 | — | — | — | — | — | 20.0 | 10.0 |
| Glass Fibers | — | — | — | 20.0 | 10.0 | 20.0 | 10.0 |
| Lubricant | 0.3 | 0.3 | 0.3 | 0.3 | 0.3 | 0.3 | 0.3 |
| Black Pigment | 5.0 | 5.0 | 5.0 | 5.0 | 5.0 | 5.0 | 5.0 |
| | Ex. 1 | Ex. 2 | Ex. 3 | Ex. 4 | Ex. 5 | Ex. 6 | Ex. 7 |
| | (parts) | (parts) | (parts) | (parts) | (parts) | (parts) | (parts) |
| PPS | 100 | 100 | 100 | 100 | 100 | 100 | 100 |
| Talc | 27 | 73 | 173 | 91 | 185 | — | — |
| Nylgos ® 8 | — | — | — | — | — | 37 | 13 |
| Glass Fibers | — | — | — | 40 | 34 | 37 | 13 |
| Lubricant | 0.4 | 0.5 | 0.9 | 0.6 | 1.0 | 0.5 | 0.4 |
| Black Pigment | 7 | 9 | 14 | 10 | 17 | 9 | 7 |

The samples noted above are also tested for mechanical properties and thermal conductivity as described herein. The results are set forth below.

| | | | | Charpy Impact | | | TC, | TC, |
|---|---|---|---|---|---|---|---|---|
| | Tensile | Tensile | Tensile | Strength | | TC, In- | Cross | Through |
| | Modulus | Strength | Elongation | (Un-Notched) | DTUL | Plane | Plane | Plane |
| | (MPa) | (MPa) | (%) | (kJ/m²) | (° C.) | (W/mk) | (W/mK) | (W/mK) |
| Ex. 1 | 6181 | 56 | 1.23 | 16.9 | 127 | 0.78 | 0.71 | 0.43 |
| Ex. 2 | 10685 | 72 | 1.16 | 11.9 | 185 | 1.99 | 1.74 | 0.58 |
| Ex. 3 | 14985 | 64 | 0.52 | 6.4 | 229 | 3.29 | 3.03 | 0.73 |
| Ex. 4 | 20702 | 92 | 0.59 | 9.7 | 273 | 2.76 | 2.43 | 1.03 |
| Ex. 5 | 18893 | 75 | 0.49 | 7.2 | 270 | 3.46 | 3.07 | 0.99 |
| Ex. 6 | 23354 | 126 | 0.76 | 17.7 | 267 | 1.30 | 0.99 | 0.93 |
| Ex. 7 | 23022 | 109 | 0.64 | 14.3 | 266 | 1.49 | 1.10 | 1.00 |
| Comp | 18500 | 125 | 1.00 | 16.0 | 275 | 0.87 | 0.81 | 0.60 |
| Ex. 1 | | | | | | | | |
| Comp. | 13808 | 105 | 1.20 | 19.7 | 260 | 1.50 | 1.30 | 0.70 |
| Ex. 2 | | | | | | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising 100 parts by weight of a polymer matrix that includes a polyarylene sulfide and from about 70 to about 250 parts by weight of a plurality of mineral particles dispersed within the polymer matrix, wherein the polymer composition exhibits an in-plane thermal conductivity of about 2 W/m-K or more as determined in accordance with ASTM E1461-13(2022).

2. The polymer composition of claim 1, wherein the polymer composition exhibits a cross-plane thermal conductivity of about 2 W/m-K or more as determined in accordance with ASTM E 1461-13(2022).

3. The polymer composition of claim 1, wherein the polymer composition exhibits an in-plane thermal conductivity of from about 3 to about 8 W/m-K, as determined in accordance with ASTM E 1461-13(2022).

4. The polymer composition of claim 1, wherein the polymer composition exhibits a melt viscosity of about 30 kP or less as determined in accordance with ISO 11443:2021 at a temperature of about 310° C. and at a shear rate of 400 s⁻¹.

5. The polymer composition of claim 1, wherein the polymer matrix constitutes from about 30 wt. % to about 70 wt. % of the polymer composition.

6. The polymer composition of claim 1, wherein the polyarylene sulfide includes a polyphenylene sulfide.

7. The polymer composition of claim 6, wherein the polyphenylene sulfide is linear.

8. The polymer composition of claim 1, wherein the mineral particles constitute from about 30 wt. % to about 70 wt. % of the polymer composition.

9. The polymer composition of claim 1, wherein the mineral particles include talc.

10. The polymer composition of claim 1, wherein the mineral particles have a median diameter of from about 1 to about 25 micrometers, specific surface area of from about 1 to about 50 m²/g as determined in accordance with DIN 66131:1993, and/or moisture content of about 5% or less as determined in accordance with ISO 787-2:1981 at a temperature of 105° C.

11. The polymer composition of claim 1, wherein the polymer composition is free of fillers having an intrinsic thermal conductivity of 100 W/m-K or more.

12. The polymer composition of claim 1, wherein the polymer composition exhibits a V-0 rating as determined in accordance with UL94 testing at a thickness of 0.8 mm.

13. The polymer composition of claim 1, wherein the polymer composition exhibits a dielectric constant of about 5 or less at a frequency of 2 GHz and a dissipation factor of about 0.01 or less at a frequency of 2 GHz.

14. A composite structure comprising a metal component in contact with a resinous component that includes the polymer composition of claim 1.

15. An electric vehicle comprising a powertrain that includes at least one electric propulsion source and a transmission that is connected to the propulsion source via at least one power electronics module, wherein the electric vehicle comprises the polymer composition of claim 1.

16. The electric vehicle of claim 15, wherein the electric vehicle comprises an electrical component comprising the polymer composition.

17. The electric vehicle of claim 16, wherein the electrical component comprises a bobbin, busbar, current sensor, inverter filter, electrical connector, a brushless direct current motor, a guide ring, a battery cell sealing ring, end cap for a motor, or a combination thereof.

18. The electric vehicle of claim 16, wherein the electrical component comprises a quick connectors, a tee, an interconnector, or a combination thereof.

19. The electric vehicle of claim 15, wherein the electric vehicle comprises a thermal management system component comprising the polymer composition.

20. The electric vehicle of claim 19, wherein the thermal management system component comprises a coolant pump.
